(19) United States
(12) Patent Application Publication
(10) Pub. No.: US 2021/0188692 A1
(43) Pub. Date: Jun. 24, 2021

(54) CONTINUOUS SMELTING AND FIBER SPINNING PROCESS

(71) Applicant: ARMSTRONG WORLD INDUSTRIES INC., Lancaster, PA (US)

(72) Inventors: Marsha S BISCHEL, Lancaster, PA (US); Benjamin J LENGLE, Marietta, PA (US); Brian BIRD, Charleston, WV (US)

(21) Appl. No.: 17/119,793

(22) Filed: Dec. 11, 2020

Related U.S. Application Data
(60) Provisional application No. 62/952,652, filed on Dec. 23, 2019.

(51) Int. Cl. C03B 37/075; C03B 37/022; C03B 37/03; C03B 37/07; C03C 13/06

(52) U.S. Cl. CPC C03B 37/075; C03B 37/022; C03C 13/06; C03B 37/07; C03B 37/03

(57) ABSTRACT

Described herein is a method of forming a smelting byproduct that can be formed into an inorganic fiber, the method comprising: a) introducing silicomanganese slag and a smelting additive into a submerged arc furnace comprising a collection zone; b) smelting the silicomanganese slag into a silicomanganese metal and a smelting byproduct, whereby the silicomanganese metal settles to a lower portion of the collection zone and the smelting byproduct gathers in an upper portion of the collection zone due to density differential between the silicomanganese metal and the smelting byproduct; c) flowing the smelting byproduct from the collection zone from a first outlet; and d) flowing the silicomanganese metal from the collection zone from a second outlet.

### CROSS-REFERENCE TO RELATED APPLICATIONS

This application claims the benefit of U.S. Provisional Application No. 62/952,652, filed on Dec. 23, 2019. The disclosure of the above application is incorporated herein by reference.

### BACKGROUND

Previously, mineral wool making operations involved melting of slag from steel making, blast furnace operations, or virgin sources—such as basalt. In such cases, residual iron may be melted out of the starting components using a coal-fire cupola to melt slag. However, cupolas are sources of carbon dioxide and sulfates due to their dependence on coal and coke. Other technologies require complex logistics for transporting molten slag to fiber processing plants, which raises significant safety and energy concerns. Therefore, a new approach for creating such fibers is needed.

### BRIEF SUMMARY

In some embodiments, the present invention is directed to a method of forming a smelting byproduct that can be formed into an inorganic fiber, the method comprising: a) introducing silicomanganese slag and a smelting additive into a submerged arc furnace comprising a collection zone; b) smelting the silicomanganese slag into a silicomanganese metal and a smelting byproduct, whereby the silicomanganese metal settles to a lower portion of the collection zone and the smelting byproduct gathers in an upper portion of the collection zone due to density differential between the silicomanganese metal and the smelting byproduct; c) flowing the smelting byproduct from the collection zone from a first outlet; and d) flowing the silicomanganese metal from the collection zone from a second outlet.

In other embodiments, the present invention includes a method of forming a smelting byproduct that can be formed into an inorganic fiber, the method comprising: a) introducing silicomanganese slag and a smelting additive into a submerged arc furnace, the submerged arc furnace comprising a collection zone having an upper portion and a lower portion, whereby the lower portion contains a first molten silicomanganese metal; b) applying power to the first molten silicomanganese metal, the first molten silicomanganese metal having a first electrical resistance, to heat the silicomanganese slag by resistance heating; c) smelting the silicomanganese slag in the heat generated in step b) to form a second molten silicomanganese metal and a smelting byproduct, whereby the second molten silicomanganese metal settles to the lower portion of the collection zone and the smelting byproduct gathers in the upper portion of the collection zone due to density differential between the second molten silicomanganese metal and the smelting byproduct; and d) flowing the smelting byproduct from the collection zone from a first outlet.

Other embodiments of the present invention include a system for the production of inorganic fiber from silicomanganese slag, the system comprising a power control device; a submerged arc furnace having a chamber, the chamber comprising: a smelting zone; and a collection zone comprising an upper portion and a lower portion; a first outlet in fluid communication with the upper portion of the collection zone; a second outlet in fluid communication with the lower portion of the collection zone; and at least two electrodes; a fiber spinning apparatus in fluid communication with the first outlet of the collection zone; wherein the lower portion of the collection zone comprises a silicomanganese metal and the power control device is configured to apply power to the silicomanganese metal through the at least two electrodes.

In other embodiments, the present invention is directed to a method of forming a smelting byproduct that can be formed into an inorganic fiber, the method comprising: a) introducing a slag and a smelting additive into a submerged arc furnace comprising a collection zone having an upper portion and a lower portion, whereby the lower portion contains a first molten metal; b) applying a power to the first molten metal, the first molten metal having a first electrical resistance, to heat the slag by resistance heating c) smelting the slag into a second molten metal and a smelting byproduct, whereby the second molten metal settles to the lower portion of the collection zone and the smelting byproduct gathers in the upper portion of the collection zone due to density differential between the second molten metal and the smelting byproduct; d) flowing the smelting byproduct from the collection zone from a first outlet; and e) flowing the second molten metal from the collection zone from a second outlet.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic representation of a system according to the present invention;

FIG. 2 is a schematic representation of a system according to the present invention;

FIG. 3 is a flow-diagram representing a methodology of the present invention; and

FIG. 4 is a flow-diagram representing a methodology of the present invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means +/−5% of the reference value. According to the present application, the term “substantially free” less than about 0.1 wt. % based on the total of the referenced value.

The present invention is directed to a method and corresponding system for smelting a starting composition into a smelting byproduct and a metal. The smelting byproduct of the present invention may be further processed into an inorganic fiber. The inorganic fiber may be an vitreous fiber. The metal may be subsequently collected and further processed based on relevant demand or applications.

In some embodiments of the present invention, the starting composition may be an ore. In other embodiments, the starting composition may be a slag. The term “ore” refers to a naturally occurring substance containing one or more metals. The ore may be a mineral or take the form of a sediment or rock (i.e., an aggregate of one or more minerals). The term “slag” refers to a glass-like byproduct of a smelting process, whereby metal is the other product of the smelting process. In a non-limiting example, the smelting process may be performed by applying heat to an ore in the presence of one or more smelting additives, such as a reducing agent, to separate the metal and slag—as discussed in greater detail herein.

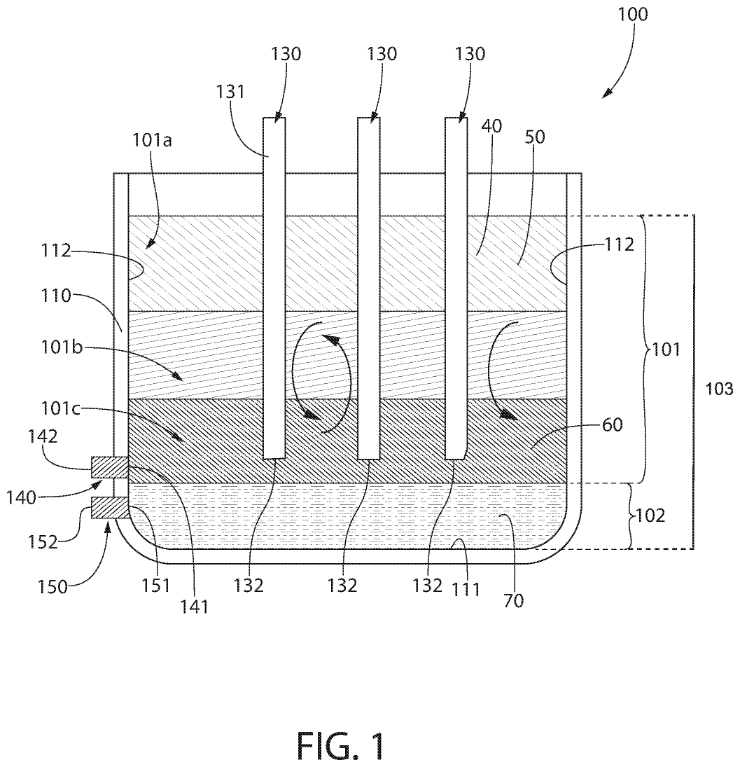

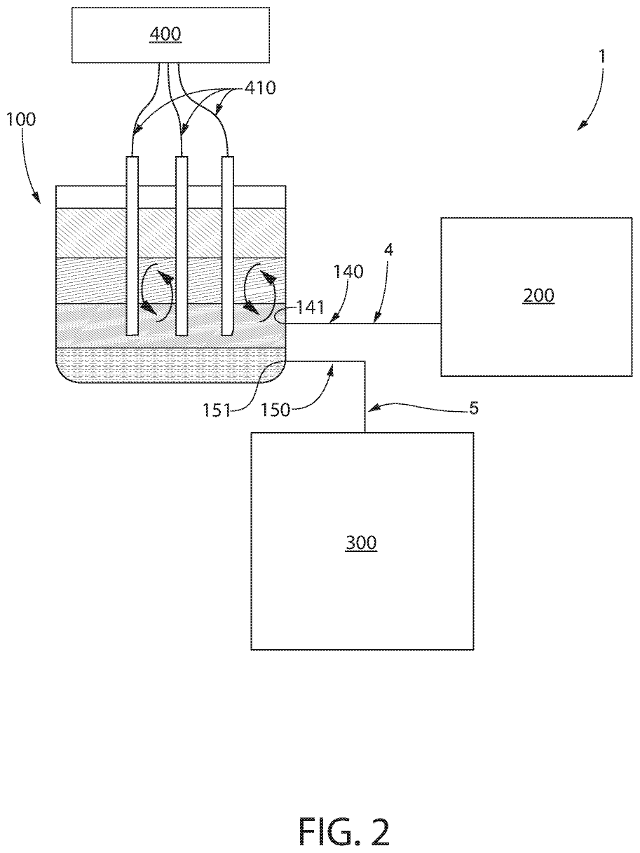

Referring now to FIGS. 1 and 2, the system 1 of the present invention comprises a submerged arc furnace 100 (also referred to as the “furnace”). The furnace 100 may comprise a chamber 110 formed by chamber walls 112 and a chamber floor 111. The chamber walls 112 and chamber floor 111 collectively defined a chamber volume.

The furnace 100 may comprise a collection zone 103 that occupies at least a portion of the chamber volume of the chamber 110. The collection zone 103 may comprise a lower portion 102 and an upper portion 101. The lower portion 102 of the collection zone 103 may be immediately adjacent to the chamber floor 111 of the chamber 110 of the furnace 100. The lower portion 102 of the collection zone 103 may overlap vertically with at least a portion of the chamber wall 112 of the chamber 110 of the furnace 100. The upper portion 101 of the collection zone 103 may be located above the lower portion 102 of the collection zone 103. The upper portion 101 of the collection zone 103 may be vertically offset from the chamber floor 111 by the lower portion 102 of the collection zone 103. The upper portion 101 of the collection zone 103 may overlap vertically with at least a portion of the chamber wall 112 of the chamber 110 of the furnace 100.

The furnace 100 may comprise a first outlet 140. The first outlet 140 may comprise a first opening 141 and a second opening 142 that allows for fluid communication from inside of the chamber 110 to outside of the chamber 110. The first outlet 140 may be in fluid communication with the upper portion 101 of the collection zone 103.

The first outlet 140 may be located within the upper portion 101 of the collection zone 103. The first outlet 140 may be located entirely above the lower portion 102 of the collection zone 103. The first outlet 140 may provide for fluid communication between at least a portion of the upper collection zone 101 inside of the chamber 110 to a first fluid communication line 4 located outside of the chamber 110 of the furnace 100.

The furnace 100 may comprise a second outlet 150. The second outlet 150 may comprise a first opening 151 and a second opening 152 that allows for fluid communication from inside of the chamber 110 to outside of the chamber 110. The second outlet 150 may be located within the lower portion 102 of the collection zone 103. The second outlet 150 may be in fluid communication with the lower portion 102 of the collection zone 103.

The second outlet 150 may be located entirely below the upper portion 101 of the collection zone 103. The second outlet 150 may provide for fluid communication between the lower collection zone 102 inside of the chamber 110 to a second fluid communication line 5 located outside of the chamber 110 of the furnace 100. The second outlet 150 may be located above the chamber floor 111 by a distance having a non-zero value.

The furnace 100 may further comprise at least two electrodes 130. In some embodiments, the furnace 100 may comprise two, three, four, five, six, seven, eight, or nine electrodes. Each electrode 130 has an electrode body 131 that terminates at a distal end 132, the electrode body 131 having an outer surface. Each electrode body 131 may be formed of carbon. In a non-limiting example, the electrode body 131 may be formed of graphite.

The furnace may further comprise one or more sensors. The sensors may include a temperature sensor—such as a thermocouple—for monitoring the temperature inside of the chamber 110 of the furnace during smelting, as discussed in greater detail herein.

The system 1 of the present invention may further comprise a power control device 400. The power control device 400 may include a power source—such as an AC or DC power generator—as well as power supply lines 410 capable of transmitting power generated by the power source to the electrodes 130 of the furnace 100. The power control device 400 may further comprise a CPU that can collect data relating to the temperature of the furnace 100 that is collected by the temperature sensors as well as the resistance within the collection zone 103—as discussed in greater detail herein. As discussed further herein, the amounts of material that is input and output from the collection zone 103 may be monitored. The CPU may use the temperature and/or resistance data as well as the amounts of material input and output to regulate the power delivered to the electrodes 130 to control the desired temperature. In a non-limiting embodiment, the CPU may use the temperature data to regulate voltage or both that is delivered to the electrodes 130 of the furnace 100.

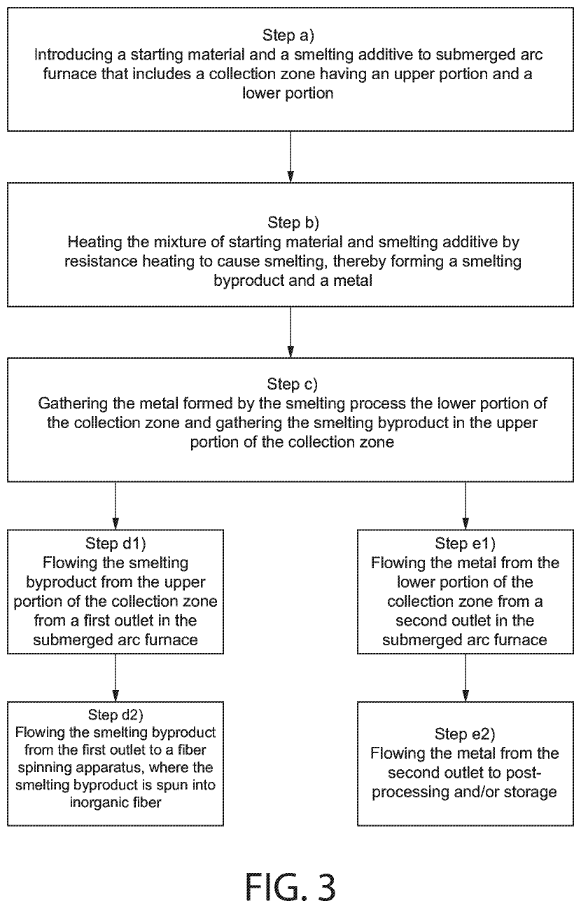

Referring now to FIGS. 1-3 concurrently, the method of the present invention may comprise a first step—step a)—of introducing a starting material into a submerged arc furnace that comprises a collection zone. The collection zone 103 may comprise an upper portion 101 and a lower portion 102. In some embodiments, step a) may further comprise introducing a smelting additive with the starting material into the submerged arc furnace.

The starting material may be an ore. In some embodiments, the starting material may be a slag. In a non-limiting embodiment, the slag may be selected from a steel slag, silicomanganese slag, ferro-silicomanganese slag, or a mixture of various slags. In a non-limiting example, the ore may include gabbro, basalt, bauxite, or manganese.

The smelting additive may comprise a reducing agent. Non-limiting examples of the smelting additive may include lime, alumina, limestone, feldspar, gravel, calcium aluminate, coke, recycled secondary slag, recycled fiber, and blends thereof.

In some embodiments, the smelting additive will be substantially free of carbon. In some embodiments, the smelting additive will be substantially free of a source of carbon—such as, but not limited to, coal, graphite, coke, and the like.

According to these embodiments, the collection zone may be substantially free of an external source of carbon. The term “external source of carbon” refers to carbon containing additives, starting materials, and/or other external compositions that are separate from the electrodes, which may be formed of carbon (graphite). Therefore, while a carbon source may be present in the collection zone in the form of the electrodes, the collection zone may still be substantially free of an external carbon source as the external carbon source is separate from the electrodes.

The following discussion will be made in reference to silicomanganese slag as the starting material—however, the application is not limited to such silicomanganese slag as the starting material or related smelting byproducts and metals.

The method further includes step b), applying heat to the collection zone 103 by resistance heating. Subsequently the method includes step c), where the silicomanganese slag and the smelting additives react in the present of the heat to cause a redox reaction, thereby releasing pure metal (herein referred to as “metal”) and a smelting byproduct from the silicomanganese slag starting material. Smelting may occur by heating the collection zone 103 to a temperature ranging from about 1400° C. to about 1700° C.—including all temperatures and sub-ranges-therebetween.

The term “pure metal” may refer to a composition comprising at least about 65% by weight of the reference metal or metal-alloy, with the remaining amounts accounted for material that is not the metal or metal alloy. In a non-limiting example, pure silicomanganese may refer to a composition containing about 60-72 wt. % of manganese, about 10 wt. % to about 25 wt. % of silicon—whereby the remaining amounts may include about 10 wt. % to about 25 wt. % of iron and trace amounts of carbon (less than 3.5 wt. %), phosphorus (less than 0.25 wt. %), and sulfur (less than 0.1 wt. %).

In some embodiments, the pure metal may meet one of Grade A, Grade B, or Grade C established by ASTM A483 Composition Requirements. In a non-limiting example, Grade A pure silicomanganese may comprise about 65 wt. % to about 68 wt. % of manganese, about 18.5 wt. %

According to this embodiment of the present invention, the smelting byproduct is a secondary slag. The term “secondary slag” refers to a composition that has been subjected to at least two smelting processes—i.e., two separate redox reactions. According to this embodiment, the pure metal may be a silicomanganese metal.

According to other embodiments where the starting material is not a slag but rather an ore, the smelting byproduct is also a slag but is not a secondary slag, as the byproduct has been subjected to only a single smelting process.

According to the embodiments where the starting material is a slag—specifically, a silicomanganese slag—the starting material may comprise a first composition that includes silicon dioxide, manganese oxide, magnesium oxide, and calcium oxide. In some embodiments, the first composition of the slag starting material may further comprise titanium dioxide, aluminum oxide, iron oxide, sodium oxide, and potassium oxide.

In a non-limiting example, the silicomanganese slag as a starting material may comprise silicon dioxide in an amount ranging from about 30 wt. % to about 60 wt. %; titanium dioxide in an amount ranging from about 0 wt. % to about 2 wt. %; aluminum oxide in an amount ranging from about 0 wt. % to about 30 wt. %; manganese oxide in an amount ranging from about 2 wt. % to about 30 wt. %; magnesium oxide in an amount ranging from about 1 wt. % to about 17 wt. %; calcium oxide in an amount ranging from about 10 wt. % to about 40 wt. %; sodium oxide in an amount ranging from about 0 wt. % to about 2 wt. %; and potassium oxide in an amount ranging from about 0 wt. % to about 3 wt. %.

According to the embodiments where the starting material is a slag—specifically, a silicomanganese slag—the secondary slag may comprise a second composition that includes silicon dioxide, aluminum oxide, manganese oxide, magnesium oxide, and calcium oxide. In some embodiments, the first composition of the slag starting material may further comprise titanium dioxide, iron oxide, sodium oxide, and potassium oxide.

In a non-limiting example, the silicomanganese slag as a starting material may comprise silicon dioxide in an amount ranging from about 35 wt. % to about 50 wt. %; titanium dioxide in an amount ranging from about 0 wt. % to about 1 wt. %; aluminum oxide in an amount ranging from about 6 wt. % to about 25 wt. %; manganese oxide in an amount ranging from about 4 wt. % to about 16 wt. %; magnesium oxide in an amount ranging from about 4 wt. % to about 16 wt. %; calcium oxide in an amount ranging from about 15 wt. % to about 27 wt. %; sodium oxide in an amount ranging from about 0 wt. % to about 2 wt. %; and potassium oxide in an amount ranging from about 0 wt. % to about 3 wt. %.

Resistance heating may occur by applying power to the electrodes 130 present in the chamber 110, whereby at least one of the starting material 40 (i.e., silicomanganese slag), the smelting byproduct 60 (i.e., secondary slag), and the metal 70 has an electrical resistance that results in heat being generated when the current passes through the respective component.

In some embodiments, the starting material 40 (i.e., silicomanganese slag) may have a first electrical resistance that results in heat being generated when the current from the electrodes 130 passes through the starting material 40. In some embodiments, the smelting byproduct 60 (i.e., secondary slag) may have a second electrical resistance that results in heat being generated when the current from the electrodes 130 passes through the smelting byproduct 60. In some embodiments, the metal 70 may have a third electrical resistance that results in heat being generated when the current from the electrodes 130 passes through the metal 70.

The first electrical resistance may form at least part of the electrical resistance that results in the resistance heating of the collection zone 103. The second electrical resistance may form at least part of the electrical resistance that results in the resistance heating of the collection zone 103. The third electrical resistance may form at least part of the electrical resistance that results in the resistance heating of the collection zone 103.

With the smelting byproduct (i.e., secondary slag) and the pure metal being formed from the redox reaction, the method further includes step c), gathering the metal 70 in the lower portion 102 of the collection zone 103 and gathering the smelting byproduct 60 in the upper portion 101 of the collection zone 103. Specifically, due to density differential between the smelting byproduct 60 (i.e., secondary slag) and the metal 70, the metal 70 drops from the upper portion 101 of the collection zone 103 and settles down in the lower portion 102 of the collection zone 103 while the smelting byproduct remains 60 in the upper portion 101 of the collection zone 103.

In a non-limiting embodiment, upper portion 101 of the collection zone 103 may comprise multiple regions. In some embodiments, the upper portion 101 of the collection zone 103 may comprise a top region 101a and a bottom region 101c, the top region 101a located above the bottom region 101c. In some embodiments, the upper portion 101 of the collection zone 103 may comprise a top region 101a, a bottom region 101c, and a middle region 101b located there-between.

In a non-limiting example, the starting material 40 and the smelting additives 50 may be added to the top region 101a of the upper collection zone 101. As the starting material 40 and the smelting additives 50 are heated, the redox reaction may occur in a middle region 101b where the smelting byproduct (i.e., secondary slag) and metal formation begins. As the redox reaction continues, the smelting byproduct 60 begins to settle at a bottom region 101c of the upper portion 101 of the collection zone 103, whereby the bottom region 101c is located below the middle region 101b of the upper portion 102 of the collection zone 101 and above the lower portion 102 of the collection zone 103. As the redox reaction continues, the metal 70 formed passes through the third portion 101c of the upper portion 101 of the collection zone 103 and settles in the lower portion 102 of the collection zone 102.

The top region 101a and the middle region 101b may overlap. The middle region 101b and the bottom region 101c may overlap. Therefore, in some embodiments, the redox reaction between the starting material 40 and the smelting additive 50 may at least begin in the top region 101a of the upper portion 101 of the collection zone 103. Additionally, in some embodiments, the redox reaction between the starting material 40 and the smelting additive 50 occur in the bottom region 101c of the upper portion 101 of the collection zone 103.

As smelting continues, the smelting byproduct 60 will gather in the upper portion 101 of the collection zone 103 while the metal 70 will continue to gather in the lower portion 102 of the collection zone 103. A smelting interface may be located at the transition between the upper portion 101 and the lower portion 102 of the collection zone 103. The smelting interface may be an intermixing of the smelting byproduct 60 (i.e., secondary slag) and the metal 70 and, therefore, may not be a sharp transition.

The vertical position of the smelting interface may fluctuate upward and downward depending on the relative amounts of the smelting byproduct 60 (i.e., secondary slag) and metal 70 inside of the chamber 110, however, generally, the smelting interface may be located below the first outlet 140 and above the second outlet 150 of the furnace 100. Under this configuration, the smelting byproduct 60 (i.e., secondary slag) may flow through only the first outlet 140 within the upper portion 101 of the collection zone 103 and the metal 70 may flow through only the second outlet 150 within the lower portion 102 of the collection zone 103.

Specifically, the method of the present invention further comprises step d1)—which includes opening the openings 141, 142 of the first outlet 140 such that the smelting byproduct 60 (i.e., secondary slag) located in the upper portion 101 of the collection zone 103 may flow freely from inside of the chamber 110 to outside of the chamber via the first outlet 140 to a first fluid communication line 4.

Independently, the method of the present invention further comprises step e1)—which includes opening the openings 151, 152 of the second outlet 150 such that the metal 70 located in the lower portion 102 of the collection zone 103 may flow freely from inside of the chamber 110 to outside of the chamber via the second outlet 150 to a second fluid communication line 5.

The smelting byproduct 60 and the metal 70 may flow through the respective first and second outlets 140, 150 at the same time—i.e., steps d1) and e1) may be performed simultaneously. In some embodiments, the smelting byproduct 60 and the metal 70 may flow through the respective first and second outlets 140, 150 in an overlapping manner—i.e., steps d1) and e1) may at least partially overlap but do not occur at identical timeframes. In some embodiments, the smelting byproduct 60 and the metal 70 may flow through the respective first and second outlets 140, 150 at separate times (non-overlapping times)—i.e., steps d1) and e1) do not overlap.

As the levels of secondary slag 60 present in upper collection zone 101 and/or the metal 70 present in the lower collection zone 102 are reduced due to each of the secondary slag 60 and the metal 70 being flowed from the respective upper collection zone 101 and lower collection zone 102, additional amounts of starting material 40 and smelting additive 50 may be added to upper collection zone 103—specifically the top region 101a of the upper portion 101 of the collection zone 103—thereby effectively recharging the redox reaction to continue the production of secondary slag 60 and metal 70.

As a result, steps a)-d1) as well as steps a)-e1) may each independently be performed as a cycle. Steps a)-d1) may be performed in a multiple number of first cycles. Steps a)-e1) may be performed in a multiple number of second cycles.

In some embodiments, steps d1) and c) are not performed concurrently with step a) of the first cycle. In some embodiments, steps d1) and c) are not performed concurrently with step b) of the first cycle. In some embodiments, steps d1) and c) are performed concurrently with step a) of the first cycle. In some embodiments, steps d1) and c) are performed concurrently with step b) of the first cycle.

In some embodiments, steps e1) and c) are not performed concurrently with step a) of the second cycle. In some embodiments, steps e1) and c) are not performed concurrently with step b) of the second cycle. In some embodiments, steps e1) and c) are performed concurrently with step a) of the second cycle. In some embodiments, steps e1) and c) are performed concurrently with step b) of the second cycle.

During at least one of steps a), b), c), d1), and e1)—the overall electrical resistance of the reaction system—i.e., the collective electrical resistance that results from the electrical resistance of the electrodes 130 and/or at least one of the first electrical resistance, the second electrical resistance, and the third electrical resistance—may vary. As the overall electrical resistance of the reaction system varies, the power control device 400 may change the amount of voltage that is applied to the electrodes 130 in order to maintain the desired amount of resistance heating needed to continue the smelting reaction.

The smelting byproduct 60 may be in a molten state when leaving the chamber 110 of the furnace 100. Therefore, the method may further comprise a step d2), whereby the smelting byproduct 60 may flow from the first outlet 140 to a fiber spinning apparatus 200 via the first fluid communication line 4. The first outlet 140 may be in fluid communication with the fiber spinning apparatus 200 via the first fluid communication line 4.

In some embodiments, the first fluid communication line 4 may function as a gravity feed. According to this embodiment, the smelting byproduct 60 may leave the chamber 110 in a molten state and be able to flow through the first fluid communication line 4 under the effects of gravity due to the natural head pressure within the chamber 110 and the flowability of the smelting byproduct 60 in the molten state.

Once the smelting byproduct 60 reaches the fiber spinning apparatus 200, the smelting byproduct may be spun into inorganic wool. Non-limiting examples of inorganic wool include rock wool, stone wool, slag wool.

The metal 70 may be in a molten state when leaving the chamber 110 of the furnace 100. Therefore, the method may further comprise a step e2), whereby the metal 70 may flow from the second outlet 150 to a post-processing or storage facility 300 via the second fluid communication line 5. The second outlet 150 may be in fluid communication with the post-processing or storage facility 300 via the second fluid communication line 5.

In some embodiments, the second fluid communication line 5 may function as a gravity feed. According to this embodiment, the metal 70 may leave the chamber 110 in a molten state and be able to flow through the second fluid communication line 5 under the effects of gravity due to the natural head pressure within the chamber 110 and the flowability of the metal 70 in the molten state.

Once the smelting byproduct 60 reaches the fiber spinning apparatus 200, the smelting byproduct may be spun into inorganic fiber. The smelting byproduct may be spun into vitreous inorganic fiber. Non-limiting examples of inorganic fiber may have a diameter ranging from about 3 microns to about 12 microns.

In some embodiments, steps d2) may not be performed concurrently with step a) of the first cycle. In some embodiments, steps d2) may not performed concurrently with step b) of the first cycle. In some embodiments, steps d2) may not performed concurrently with step c) of the first cycle. In some embodiments, steps d2) may be performed concurrently with step a) of the first cycle. In some embodiments, steps d2) may be performed concurrently with step b) of the first cycle. In some embodiments, steps d2) may be performed concurrently with step c) of the first cycle.

In some embodiments, steps e2) may not be performed concurrently with step a) of the second cycle. In some embodiments, steps e2) may not performed concurrently with step b) of the second cycle. In some embodiments, steps e2) may not performed concurrently with step c) of the second cycle. In some embodiments, steps e2) may be performed concurrently with step a) of the second cycle. In some embodiments, steps e2) may be performed concurrently with step b) of the second cycle. In some embodiments, steps e2) may be performed concurrently with step c) of the second cycle.

Referring now to FIGS. 1, 2, and 4 concurrently, the method of the present invention may comprise a first step—step a)—of introducing a starting material and a smelting additive into a submerged arc furnace having a collection zone that comprises an upper portion 101 and a lower portion 102—whereby the lower portion 102 contains a first molten metal 70.

The starting material may be one of the starting materials previously discussed. According to the embodiments where the smelting process includes a smelting additive, the smelting additive may be one of the smelting additives previously discussed. The process of this embodiment may also be performed with no smelting additive.

The first molten metal 70 may be the same type of metal that is formed from the smelting process previously discussed—i.e., a pure metal that is formed from a redox reaction.

The method further includes step b), applying power to the collection zone 103 through the at least two electrodes 130 present in the chamber 110. The current from the applied power arcs to the first molten metal 70 located within the lower portion 102. According to this embodiment, the distal ends 132 of the electrodes 130 may be present within the upper portion 101 of the collection zone 103 or may be present within the lower portion 102 of the collection zone 103, however, the distal ends 132 do not contact the first molten metal 70 present in the lower portion 102 of the collection zone 103. Stated otherwise, the distal end 132 of the electrodes may be separated from the lower portion 102 of the collection zone by a non-zero distance.

The first molten metal 70 may have a fourth electrical resistance. The first molten metal 70 may provide a stable arc between the multiple electrodes 130 allowing for current to flow within the furnace 100, thereby generating heat via electrical resistance for the smelting process. The first electrical resistance of the starting material may be greater than the fourth electrical resistance of the first molten metal 70.

Subsequently, the method of this embodiment further comprises step c), where the silicomanganese slag and the smelting additives react in the present of the heat generated from step b) to cause a redox reaction, thereby releasing pure metal (herein referred to as “metal”) and a smelting byproduct from the starting material. Smelting may occur by heating the collection zone 103 to a temperature ranging from about 1400° C. to about 1700° C.—including all temperatures and sub-ranges-therebetween.

As the smelting byproduct (i.e., secondary slag) and the pure metal are formed from the redox reaction, the metal 70 settles in the lower portion 102 of the collection zone 103 and the smelting byproduct 60 settles in the upper portion 101 of the collection zone 103 due to density differential between the smelting byproduct 60 (i.e., secondary slag) and the metal 70.

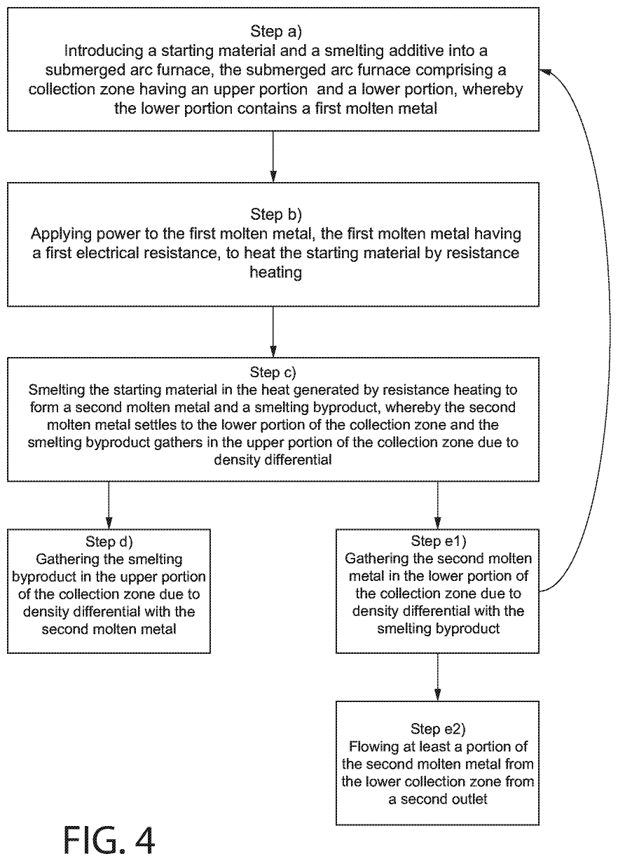

The method of the present invention further comprises step d)—gathering the smelting byproduct in the upper portion 101 of the collection zone 103. Although not shown as part of the flow-chart of FIG. 4, the smelting byproduct may then flow through the first outlet 140 to outside of the chamber via the first outlet 140 to a first fluid communication line 4. Steps a), b), c), and d)—as well as subsequent flowing of smelting byproduct to through the first outlet 140 to the first fluid communication line 4, may be performed as a cycle.

Independently, the method of the present invention further comprises step e1)—gathering the metal 70 in the lower portion 102 of the collection zone 103. The metal 70 that gathers inside of the lower portion 102 of the collection zone 103 may be a second molten metal 70. The second molten metal 70 may be identical to the first molten metal 70 present in step a) of this embodiment. As a result, steps a), b), c), and e1) may be performed as a cycle—whereby the second molten metal at the end of one cycle forms the first molten metal of the beginning of a subsequent cycle.

During at least one of steps a), b), c), d1), and e1)—the overall electrical resistance of the reaction system—i.e., the collective electrical resistance that results from the electrical resistance of the electrodes 130 and/or at least one of the first electrical resistance, the second electrical resistance, the third electrical resistance, and the fourth electrical resistance—may vary. As the overall electrical resistance of the reaction system varies, the power control device 400 may change the amount of voltage that is applied to the electrodes 130 in order to maintain the desired amount of resistance heating needed to continue the smelting reaction.

In some embodiments, the system 1 may comprise a position control that allows the vertical position of the electrodes 130 to be changed within the collection zone 103. Specifically, the position control may allow the electrodes 130 to change vertical position thereby either increasing or decreasing the distance that separates the distal end 132 of the electrodes 130 from the lower portion 102 of the collection zone 103. As the distance between the distal end 132 of the electrodes 130 and the lower portion 102 of the collection zone 103 varies the collective electrical resistance may also change, thereby providing a mechanism to actively change the overall electrical resistance of the reaction system to provide another variable that allows the system 1 to achieve the desired smelting temperature.

In a subsequent step e2), the metal 70 present in the lower collection zone 102 may flow from the second outlet 150 to a post-processing or storage facility 300 via the second fluid communication line 5.

1. A method of forming a smelting byproduct that can be formed into an inorganic fiber, the method comprising:
a) introducing silicomanganese slag into a submerged arc furnace comprising a collection zone;
b) smelting the silicomanganese slag into a silicomanganese metal and a smelting byproduct, whereby the silicomanganese metal settles to a lower portion of the collection zone and the smelting byproduct gathers in an upper portion of the collection zone due to density differential between the silicomanganese metal and the smelting byproduct;
c) flowing the smelting byproduct from the collection zone from a first outlet; and
d) flowing the silicomanganese metal from the collection zone from a second outlet.

2. The method according to claim 1, wherein step b) comprises applying power to the silicomanganese slag such that the silicomanganese slag is smelted by resistance heating.

3-5. (canceled)

6. The method according to claim 1, wherein step c) further comprises:
c-1) flowing the smelting byproduct from the first outlet to a fiber spinning apparatus;
c-2) processing the smelting byproduct by the fiber spinning apparatus to form the inorganic fiber.

7-8. (canceled)

9. The method according to claim 1, wherein the silicomanganese slag comprises a first composition that includes silicon dioxide, manganese oxide, magnesium oxide, and calcium oxide.

10. The method according to claim 1, wherein steps a)-d) are performed in a number of cycles.

11. The method according to claim 10, wherein:
i) steps c) and d) are not performed concurrently with step a);
ii) steps c) and d) are not performed concurrently with step b);
iii) steps c) and d) are performed concurrently with step a); or
iv) steps c) and d) are performed concurrently with step b).

12-14. (canceled)

15. The method according to claim 1, wherein one or more of:
i) the first outlet is in fluid communication with the upper portion of the collection zone; and
ii) the second outlet is in fluid communication with the lower portion of the collection zone.

16-17. (canceled)

18. The method according to claim 1, wherein step a) further comprises introducing a smelting additive with the silicomanganese slag into the submerged arc furnace, wherein the smelting additive is selected from lime, alumina, limestone, gravel, calcium aluminate, feldspar, recycled fiber, coke, and blends thereof.

19. The method according to claim 1, wherein the collection zone is substantially free of an external source of carbon.

20-33. (canceled)

34. A system for the product of inorganic fiber from silicomanganese slag, the system comprising
a power control device;
a submerged arc furnace having a chamber, the chamber comprising:
a collection zone comprising an upper portion and a lower portion;
a first outlet in fluid communication with the upper portion of the collection zone;
a second outlet in fluid communication with the lower portion of the collection zone; and
at least two electrodes;
a fiber spinning apparatus in fluid communication with the first outlet of the collection zone;
wherein the lower portion of the collection zone comprises a silicomanganese metal and the power control device is configured to apply power to the silicomanganese metal through the at least two electrodes.

35. The system according to claim 34, wherein the submerged arc furnace comprises three or more electrodes.

36. The system according to claim 34, wherein:
i) the at least two electrodes are present in the upper portion of the collection zone; or
ii) the at least two electrodes are present in the lower portion of the smelting zone.

37. (canceled)

38. The system according to claim 34, wherein the fiber spinning apparatus is an inorganic fiber spinning apparatus.

39. (canceled)

40. The system according to claim 34, wherein the first outlet is in fluid communication with the fiber spinning apparatus via a gravity feed.

41. The system according to claim 34, wherein the chamber is substantially free of an external source of carbon.

42. A method of forming a smelting byproduct that can be formed into an inorganic fiber, the method comprising:
a) introducing a slag into a submerged arc furnace comprising a collection zone having an upper portion and a lower portion, whereby the lower portion contains a first molten metal;
b) applying power to the first molten metal, the first molten metal having a first electrical resistance, to heat the slag by resistance heating;
c) smelting the slag into a second molten metal and a smelting byproduct, whereby the second molten metal settles to the lower portion of the collection zone and the smelting byproduct gathers in the upper portion of the collection zone due to density differential between the second molten metal and the smelting byproduct;
d) flowing the smelting byproduct from the collection zone from a first outlet; and
e) flowing the second molten metal from the collection zone from a second outlet.

43-45. (canceled)

46. The method according to claim 42, wherein step d) further comprises:
d-1) flowing the smelting byproduct from the first outlet to a fiber spinning apparatus;
d-2) processing the smelting byproduct by the fiber spinning apparatus to form the inorganic fiber.

47. The method according to claim 42, wherein steps a)-e) are performed in a number of cycles.

48. The method according to claim 47, wherein:
i) steps d) and c) are not performed concurrently with step a);
ii) steps d) and c) are not performed concurrently with step b);
iii) steps d) and e) are performed concurrently with step a); or
iv) steps d) and e) are performed concurrently with step b).

49-55. (canceled)

56. The method according to claim 42, wherein:
i) step a) further comprises introducing a smelting additive with the silicomanganese slag into the submerged arc furnace, wherein the smelting additive is selected from lime, alumina, limestone, calcium aluminate, feldspar, recycled fiber, and blends thereof; or
ii) step a) further comprises introducing a smelting additive with the silicomanganese slag into the submerged arc furnace, wherein the smelting additive is selected from lime, alumina, limestone, gravel, calcium aluminate, feldspar, recycled fiber, coke, and blends thereof.

57. (canceled)
